(19) United States
(12) Patent Application Publication
(10) Pub. No.: US 2016/0029074 A1
(43) Pub. Date: Jan. 28, 2016

(54) Apparatus and Method for Processing Program Content Recoding

(71) Applicant: THOMSON LICENSING, Issy-les Moulineaux (FR)

(72) Inventors: Chaminda Jayamanne, Fishers, IN (US); Steven Lee Cooper, Whitestown, IN (US)

(21) Appl. No.: 14/803,554

(22) Filed: Jul. 20, 2015

Related U.S. Application Data
(60) Provisional application No. 62/027,802, filed on Jul. 23, 2014.

(51) Int. Cl. H04N 21/433; H04N 21/44; H04N 21/482; H04N 21/472; H04N 21/4147; H04N 21/458

(52) U.S. Cl. CPC H04N 21/4334; H04N 21/4147; H04N 21/458; H04N 21/4821; H04N 21/47214; H04N 21/44008

(57) ABSTRACT

The present principles of the embodiments generally relate to an apparatus and a method for processing media asset recordings such as, e.g., recording of a television program in an electronic device, such as, e.g., a digital video recorder (DVR). In one exemplary embodiment, the present invention is able to automatically record another occurrence of a requested program as a potential replacement when the original recording of the requested program contains an abnormality such as e.g., an error and/or a program interruption. The potential replacement program may be from a different source such as an internet media service website.

### CROSS-REFERENCE TO RELATED APPLICATIONS

This application claims benefit under 35 U.S.C. §119 of U.S. Provisional Patent Application No. 60/027,802 filed on Jul. 23, 2014.

### BACKGROUND OF THE INVENTION

1. Field of the Invention

The present principles of the embodiments generally relate to an apparatus and a method for processing media asset recordings such as, e.g., recording of a television program in an electronic device, such as, e.g., a digital video recorder (DVR). In one exemplary embodiment, the present invention is able to automatically record another occurrence of a requested program as a potential replacement when the original recording of the requested program contains an abnormality such as e.g., an error and/or a program interruption. The potential replacement program may be from a different source such as an internet media service website.

2. Background Information

Electronic devices such as, e.g., televisions, digital video recorders, personal computers (PCs), tablets, cellphones, and etc., require a control system that includes a user interface system. Typically, a user interface system provides information to and receives information from a user and simplifies the usage of a device. One example of a user interface system is an electronic program guide and its associated user interaction menu and control functions in an electronic device, as shown in FIG. 1 and FIG. 2. An electronic program guide provides program information such as, e.g., name and time of a program, source of a program (e.g., channel number or internet address), and other information related to the media assets, and facilitates the searching and recording of the media assets. from various sources, such as, for example, broadcast, satellite, internet sites, local storage media, and etc.

Program guide information typically comprises programming information for a program or a media asset such as, for example, media asset title, program station channel and name or media asset source such as internet URL address, start time, end time, elapsed time, time remaining, review rating, parental guide rating, genre, actors/actresses, director, producer, description of the program's content, and etc. For example, as illustrated in FIG. 2, when a user highlights a media asset such as the movie ZULU in a program guide 290 (e.g., using a cursor 294 in FIG. 2), additional program information 291 for the movie ZULU may be shown, including e.g., information about movie title, stars, producer, parental guide rating, reviewing rating, and plot.

U.S. Pat. No. 6,111,611, issued to Ozkan et al., describes in detail an exemplary embodiment of an electronic program guide system for providing program guide information to an electronic device, including exemplary data packet structure for carrying the program guide information from a provider to an electronic device. The exemplary data packet structure is designed so that both the channel information (e.g., channel name, call letters, channel number, and etc.) and the program description information (e.g., title, rating, program description, and etc.) relating to a program may be transmitted from a program guide database provider to a receiving apparatus. The teachings of this patent are incorporated herein by reference in their entirety.

In addition, different streaming media sites (e.g., Itune, Hulu, Netflix, M-GO, etc.) currently provide various user interface screens and functions for users to search media asset information such as available video titles and their related information on their respective websites. The users may search, e.g., different movie titles available on these websites by typing in a query string using keyboards on their e.g., PCs, laptops, cellphones, and etc. Different media contents provided by these sites may be accessed by a user device via e.g., a streaming protocol such as e.g., Apple HTTP Live Streaming (HLS) protocol, Adobe Real-Time Messaging Protocol (RTMP), Microsoft Silverlight Smooth Streaming Transport Protocol, and etc., or a downloading protocol such as e.g., HTTP, FTP, and etc., as well known by persons skilled in the art.

In addition, as shown in FIG. 2, once a program or media asset such as a movie “ZULU” 230 is selected by a user (using e.g., a user interface device such as a mouse, keyboard, touch screen, etc.), the user may also record the program or media asset in a storage device for later viewing by, e.g., selecting “RECORD” icon 293.

Current DVRs can typically record a program and is able to determine if the recording contains errors. These errors may be due to any number of problems including receiving errors, hard drive failure, power outages, or other program interruptions. While the user may be satisfied with what is left, it is desirable for the recording system to identify that errors exist, and to further attempt to find an alternate opportunity to re-record the program at a later time. For example, it is believed that a DISH network DVR system will show a user if a program contains errors and may not be available in its entirety.

### SUMMARY OF THE INVENTION

The present inventors recognize the needs to improve the existing systems and methods for processing program or media asset recording.

According to an exemplary aspect of the present invention, an apparatus is presented, comprising:

an interface capable for receiving a request to record a program;

a processor capable for processing said request; and

the processor capable for determining whether the first recorded version of the program contains an occurrence of abnormality, if the first recorded version of the program contains an occurrence of abnormality, then automatically determining using a program guide, a subsequent occurrence of the program and recording the subsequent occurrence of the program as a second version of the recorded program.

In another exemplary embodiment, a method is presented comprising:

receiving a request to record a program;

recording a first version of the program;

determining whether the first recorded version of the program contains an occurrence of abnormality; and

if the first recorded version of the program contains an occurrence of abnormality, then determining automatically using a program guide, a subsequent occurrence of the program; and

recording the subsequent occurrence of the program as a second recorded version of the program.

In another exemplary embodiment, a method is presented comprising:

receiving a request to record a program from a first source;

recording a first version of the program from the first source;

determining whether the first recorded version of the program from the first source contains an occurrence of abnormality; and

if the first recorded version of the program from the first source contains an occurrence of abnormality, then determining automatically an availability of the program from a second source.

In accordance with another exemplary aspect of the present invention, a computer program product stored in a non-transitory computer-readable storage media comprising computer-executable instructions for:

receiving a request to record a program;

recording a first version of the program;

determining whether the first recorded version of the program contains an occurrence of abnormality; and

if the first recorded version of the program contains an occurrence of abnormality, then determining automatically using a program guide, a subsequent occurrence of the program; and

receiving a request to record a program;

recording a first version of the program;

determining whether the first recorded version of the program contains an occurrence of abnormality; and

if the first recorded version of the program contains an occurrence of abnormality, then determining automatically using a program guide, a subsequent occurrence of the program; and

recording the subsequent occurrence of the program as a second version of the recorded program.

### BRIEF DESCRIPTION OF THE DRAWINGS

The above-mentioned and other features and advantages of the invention, and the manner of attaining them, will become more apparent and the invention will be better understood by reference to the following description of embodiments of the invention taken in conjunction with the accompanying drawings, wherein:

FIG. 1 shows an existing program guide system in an electronic device;

FIG. 2 shows another existing program guide system in an electronic device;

FIG. 3 shows an exemplary apparatus according to the principles of the present invention;

FIG. 4 and FIG. 5 show exemplary user interfaces and their functions of an exemplary electronic device according to the principles of the present invention;

FIG. 6 shows an exemplary process according to the principles of the present invention.

The examples set out herein illustrate exemplary embodiments of the invention. Such examples are not to be construed as limiting the scope of the invention in any manner.

### DETAILED DESCRIPTION

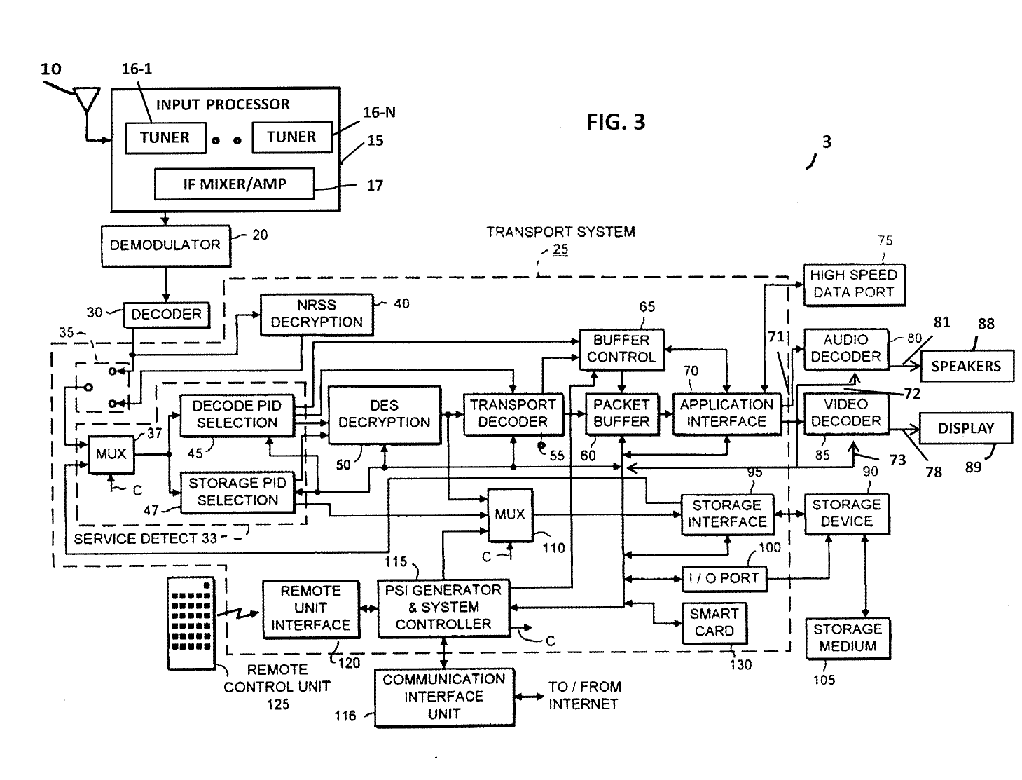

Referring now to the drawings, and more particularly to FIG. 3, FIG. 3 shows an exemplary embodiment of an electronic device 3 capable of the system shown in FIG. 3 is exemplary only. Other non-MPEG compatible systems, involving systems capable of processing other types of non-MPEG related encoded data streams (e.g., VP8) may also be used according to the principles of the present invention.

Other exemplary devices may include mobile devices such as cellular telephones, tablets, PCs, or devices combining computer and television functions such as the so-called “PCTVs”. The term “program” and “media asset” as used herein are interchangeable and represent any form of content data such as digital video and/or audio information, including streaming and stored data content received via cable, satellite, broadcast and other telecommunications networks, or via local networks or connections, such as WiFi, USB, HDMI, or Firewire connections. The media content can be from a remote source (e.g., an internet server, TV broadcaster, and etc.) or from a local source, such as from a local storage media (e.g., hard drives, memory cards or USB memory sticks, etc.).

As an overview, in the video receiver system 3 of FIG. 3, a carrier modulated with video data and/or audio data is received by antenna 10 and processed by input processor unit 15. The resultant digital output signal is demodulated by demodulator 20 and decoded by decoder 30. The output from decoder 30 is processed by transport system 25 which is responsive to commands from a user control/remote control unit 125. System 25 provides compressed data outputs for storage, further decoding, or communication to other devices.

Video decoder/processor 85 and audio decoder/processor 80 respectively, decodes the compressed data from system 25 to provide outputs for display 89 and speakers 88. Data port 75 provides an interface for communication of the compressed data from system 25 to/from other devices such as a computer or a High Definition Television (HDTV) receiver, for example. Storage device 90 stores compressed data from system 25 on storage medium 105. Device 90, in a playback mode may also support retrieval of the compressed or uncompressed video and audio data from another storage medium 105 for processing by system 25 for decoding, communication to other devices or storage on a different storage medium (not shown to simplify drawing). Although storage device 90 and storage medium 105 are shown as different memory devices in FIG. 3, one skilled in the art can readily recognize that they may also be implemented as the same memory device.

Considering FIG. 3 in detail, a carrier modulated with video and/or audio data, including e.g., digital video content, digital radio data, and etc., received by antenna 10, is converted to digital form and processed by input processor 15. Input processor 15 includes one or more radio frequency (RF) tuners 16-1 to 16-N for tuning to one or more broadcast channels concurrently. The input processor 15 which comprises turners 16-1 to 16-N, intermediate frequency (IF) mixer and amplifier 17 then tunes and down-converts the respective input video signal to a lower frequency band suitable for further processing. The resultant digital output signal is demodulated by demodulator 20 and decoded by decoder 30. The output from decoder 30 is further processed by transport system 25.

Multiplexer (mux) 37 of service detector 33 is provided, via selector 35, with either the output from decoder 30, or the decoder 30 output is further processed by a descrambling unit 40. Descrambling unit 40 may be, for example, a removable unit such as a smart card in accordance with ISO 7816 and NRSS (National Renewable Security Standards) Committee standards (the NRSS removable conditional access system is defined in EIA Draft Document IS-679, Project PN-3639), or a CableCARD used in U.S. cable systems. Selector 35 detects the presence of an insertable, compatible, descrambling card and provides the output of unit 40 to mux 37 only if the card is currently inserted in the video receiver unit. Otherwise selector 35 provides the output from decoder 30 to mux 37. The presence of the insertable card permits unit 40 to descramble additional premium program channels, for example, and provide additional program services to a viewer. In an exemplary embodiment, NRSS unit 40 and smart card unit 130 (smart card unit 130 is discussed later) share the same system 25 interface such that only either an NRSS card or a smart card may be inserted at any one time. However, the interfaces may also be separate to allow parallel operation.

The data provided to mux 37 from selector 35 is in the form of an MPEG compliant packetized transport data stream as defined e.g., in MPEG2 Systems Standards ISO_IEC 13818-1 and may include program guide information and the data content of one or more program channels. The individual packets that comprise particular program channels are identified by Packet Identifiers (PIDs). The transport stream contains Program Specific Information (PSI) for use in identifying the PIDs and assembling individual data packets to recover the content of all the program channels that comprise the packetized data stream. Transport system 25, under the control of the system controller or processor 115, acquires and collates program guide information from the input transport stream, storage device 90 or an Internet service provider via the communication interface unit 116. The individual packets that comprise either particular program channel content or program guide information, are identified by their Packet Identifiers (PIDs) contained within header information. Program guide information may contain descriptions for a program which may comprise different program descriptive fields such as title, star, ratings, genre, detailed event description, and etc., relating to a program.

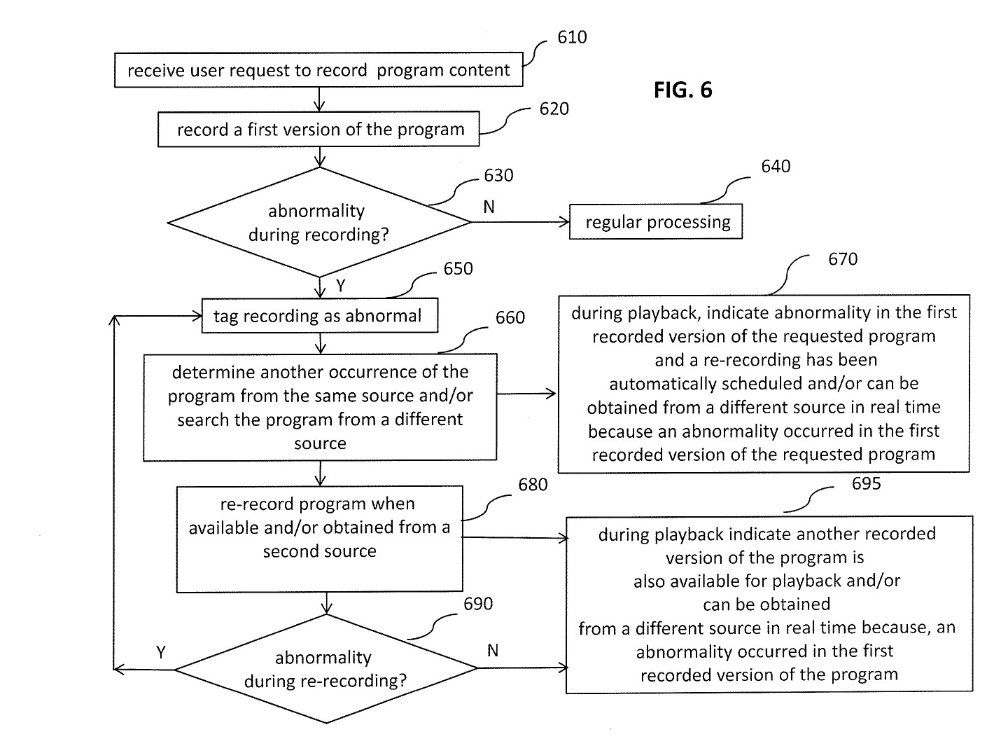

The user interface system incorporated in the video receiver 3 shown in FIG. 3 enables a user to activate various features by selecting a desired feature from an on-screen display (OSD) menu. The OSD menu may include an electronic program guide as described above and other selectable user features according to the principles of the present invention, and to be described in more detail below. Data representing information displayed in the OSD menu is generated by, e.g., system controller 115 in response to stored program guide information, stored graphics information, system and user interface control information as described herein and in accordance with an exemplary control program to be shown in FIG. 6, and to be described in detail later. The software control programs may be stored, for example, in embedded memory of system controller 115, or other suitable memory (both not shown) as well known by one skilled in the art.

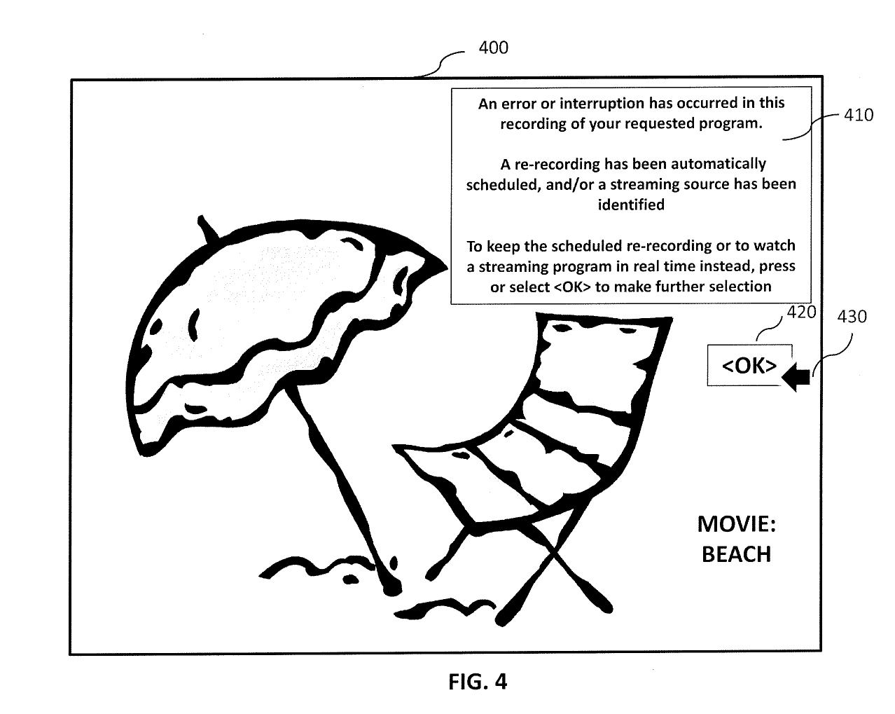

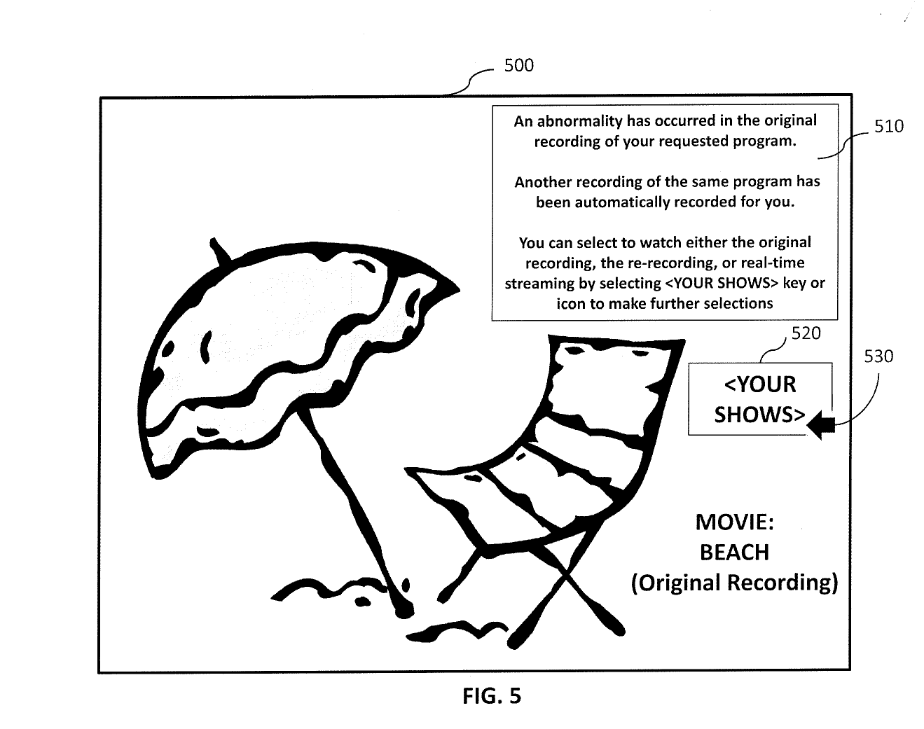

Exemplary embodiment of a user control unit 125 may include one or more of, e.g., a wired or wireless remote control, a mouse, a keyboard, voice activated device, gesture activated devices, and etc. A user may use a user control unit 125 to move a curser (e.g., 430 in FIG. 4 or 530 in FIG. 5), to select one of a plurality of user selectable icons (e.g., 420 in FIG. 4 or 520 in FIG. 5). Such user selectable icons may represent e.g., a media asset to be selected, a specific feature or function, a navigational icon, and etc.

A user is able to make various user selections via user control unit 125 as described above. System controller/processor 115 uses the selection information, provided via remote unit interface 120, to configure the various associated elements of system 3 shown in FIG. 3, in response to the user selections. For example, system controller 115 provides associated control information to audio processor 80 and video processor 85 via control signal paths 72 and 73 respectively to control their respective functions.

In addition, when a user selects programs for viewing or for storage, system controller 115 generates PSI (Program Specific Information) suitable for the selected storage device and media. Controller 115 also configures system 25 elements 45, 47, 50, 55, 65 and 95 by setting control register values within these elements via a data bus and by selecting signal paths via muxes 37 and 110 with control signal C.

In response to control signal C, mux 37 selects either, the transport stream from unit 35, or in a playback mode, a data stream retrieved from storage device 90 via store interface 95. In normal, non-playback operation, the data packets comprising the program that the user selected to view are identified by their PIDs by selection unit 45. If an encryption indicator in the header data of the selected program packets indicates the packets are encrypted, unit 45 provides the packets to decryption unit 50. Otherwise unit 45 provides non-encrypted packets to transport decoder 55. Similarly, the data packets comprising the programs that the user selected for storage are identified by their PIDs by selection unit 47. Unit 47 provides encrypted packets to decryption unit 50 or non-encrypted packets to mux 110 based on the packet header encryption indicator information.

The functions of decryptors 40 and 50 may be implemented in a single removable smart card which is compatible with the NRSS standard. This approach places all security related functions in one removable unit that easily can be replaced if a service provider decides to change encryption technique or to permit easily changing the security system, e.g., to descramble a different service.

Units 45 and 47 employ PID detection filters that match the PIDs of incoming packets provided by mux 37 with PID values pre-loaded in control registers within units 45 and 47 by controller 115. The pre-loaded PIDs are used in units 47 and 45 to identify the data packets that are to be stored and the data packets that are to be decoded for use in providing a video image. The pre-loaded PIDs are stored in look-up tables in units 45 and 47. The PID look-up tables are memory mapped to encryption key tables in units 45 and 47 that associate encryption keys with each pre-loaded PID. The memory mapped PID and encryption key look-up tables permit units 45 and 47 to match encrypted packets containing a pre-loaded PID with associated encryption keys that permit their decryption. Non-encrypted packets do not have associated encryption keys. Units 45 and 47 provide both identified packets and their associated encryption keys to decryptor 50. The PID look-up table in unit 45 is also memory mapped to a destination table that matches packets containing pre-loaded PIDs with corresponding destination buffer locations in packet buffer 60. The encryption keys and destination buffer location addresses associated with the programs selected by a user for viewing or storage are pre-loaded into units 45 and 47 along with the assigned PIDs by controller 115. The encryption keys are generated by ISO 7816-3 compliant smart card system 130 from encryption codes extracted from the input data stream. The generation of the encryption keys is subject to customer entitlement determined from coded information in the input data stream and/or pre-stored on the insertable smart card itself (International Standards Organization document ISO 7816-3 of 1989 defines the interface and signal structures for a smart card system).

The packets provided by units 45 and 47 to unit 50 are encrypted using an encryption techniques such as the Data Encryption Standard (DES) defined in Federal Information Standards (FIPS) Publications 46, 74 and 81 provided by the National Technical Information Service, Department of Commerce. Unit 50 decrypts the encrypted packets using corresponding encryption keys provided by units 45 and 47 by applying decryption techniques appropriate for the selected encryption algorithm. The decrypted packets from unit 50 and the non-encrypted packets from unit 45 that comprise the program for display are provided to decoder 55. The decrypted packets from unit 50 and the non-encrypted packets from unit 47 that comprise the program for storage are provided to mux 110.

Unit 60 contains four packet buffers accessible by controller 115. One of the buffers is assigned to hold data destined for use by controller 115 and the other three buffers are assigned to hold packets that are destined for use by application devices 75, 80 and 85. Access to the packets stored in the four buffers within unit 60 by both controller 115 and by application interface 70 is controlled by buffer control unit 65. Unit 45 provides a destination flag to unit 65 for each packet identified by unit 45 for decoding. The flags indicate the individual unit 60 destination locations for the identified packets and are stored by control unit 65 in an internal memory table. Control unit 65 determines a series of read and write pointers associated with packets stored in buffer 60 based on the First-In-First-Out (FIFO) principle. The write pointers in conjunction with the destination flags permit sequential storage of an identified packet from units 45 or 50 in the next empty location within the appropriate destination buffer in unit 60. The read pointers permit sequential reading of packets from the appropriate unit 60 destination buffers by controller 115 and application interface 70.

The non-encrypted and decrypted packets provided by units 45 and 50 to decoder 55 contain a transport header as defined by section 2.4.3.2 of the MPEG systems standard. Decoder 55 determines from the transport header whether the non-encrypted and decrypted packets contain an adaptation field (per the MPEG systems standard). The adaptation field contains timing information including, for example, Program Clock References (PCRs) that permit synchronization and decoding of content packets. Upon detection of a timing information packet, that is a packet containing an adaptation field, decoder 55 signals controller 115, via an interrupt mechanism by setting a system interrupt, that the packet has been received. In addition, decoder 55 changes the timing packet destination flag in unit 65 and provides the packet to unit 60. By changing the unit 65 destination flag, unit 65 diverts the timing information packet provided by decoder 55 to the unit 60 buffer location assigned to hold data for use by controller 115, instead of an application buffer location.

Upon receiving the system interrupt set by decoder 55, controller 115 reads the timing information and PCR value and stores it in internal memory. PCR values of successive timing information packets are used by controller 115 to adjust the system 25 master clock (27 MHz). The difference between PCR based and master clock based estimates of the time interval between the receipt of successive timing packets, generated by controller 115, is used to adjust the system 25 master clock. Controller 115 achieves this by applying the derived time estimate difference to adjust the input control voltage of a voltage controlled oscillator used to generate the master clock. Controller 115 resets the system interrupt after storing the timing information in internal memory.

Packets received by decoder 55 from units 45 and 50 that contain program content including audio, video, caption, and other information, are directed by unit 65 from decoder 55 to the designated application device buffers in packet buffer 60. Application control unit 70 sequentially retrieves the audio, video, caption and other data from the designated buffers in buffer 60 and provides the data to corresponding application devices 75, 80 and 85. The application devices comprise audio and video decoders 80 and 85 and high speed data port 75. For example, packet data corresponding to a composite program guide generated by the controller 115 as described above, may be transported to the video decoder 85 for formatting into video signal suitable for display on a display monitor 89 connected to the video decoder 85. Also, for example, data port 75 may be used to provide high speed data such as computer programs, for example, to a computer. Alternatively, port 75 may be used to output or receive data to and from an HDTV to display or process images corresponding to a selected program or a program guide, for example. One example of port 75 may be a HDMI data port.

Packets that contain PSI information are recognized by unit 45 as destined for the controller 115 buffer in unit 60. The PSI packets are directed to this buffer by unit 65 via units 45, 50 and 55 in a similar manner to that described for packets containing program content. Controller 115 reads the PSI from unit 60 and stores it in internal memory.

Controller 115 also generates condensed PSI (CPSI) from the stored PSI and incorporates the CPSI in a packetized data stream suitable for storage on a selectable storage medium. The packet identification and direction is governed by controller 115 in conjunction with the unit 45 and unit 47 PID, destination and encryption key look-up tables and control unit 65 functions in the manner previously described.

In addition, controller 115 is coupled to a communication interface unit 116. Unit 116 provides the capability to upload and download information to and from the internet. Communication interface unit 116 includes, for example, communication circuitry for connecting to an internet service provider, e.g., via a wired or wireless connection such as an Ethernet, WiFi connection, or via cable, fiber or telephone line. The communication capability allows the system shown in FIG. 3 to access and provide, e.g., Internet related features such as program content information searching (e.g., via a program guide), program content streaming and web browsing, in addition to receiving television and radio programming. Also, it allows the exemplary system shown in FIG. 3 to obtain electronic program guide information from a provider through the internet, even though a program itself may be from a non-internet source.

FIG. 4 and FIG. 5 illustrate exemplary user interface screens and functions according to the principles of the present invention. These user interface screens and functions may be controlled and/or provided by e.g., system controller/processor 115 in receiver 3 of FIG. 3.

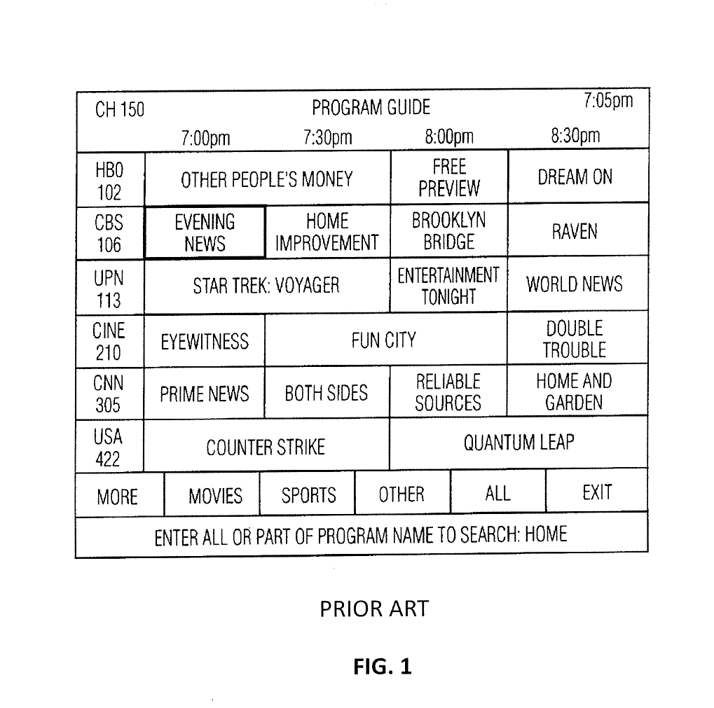

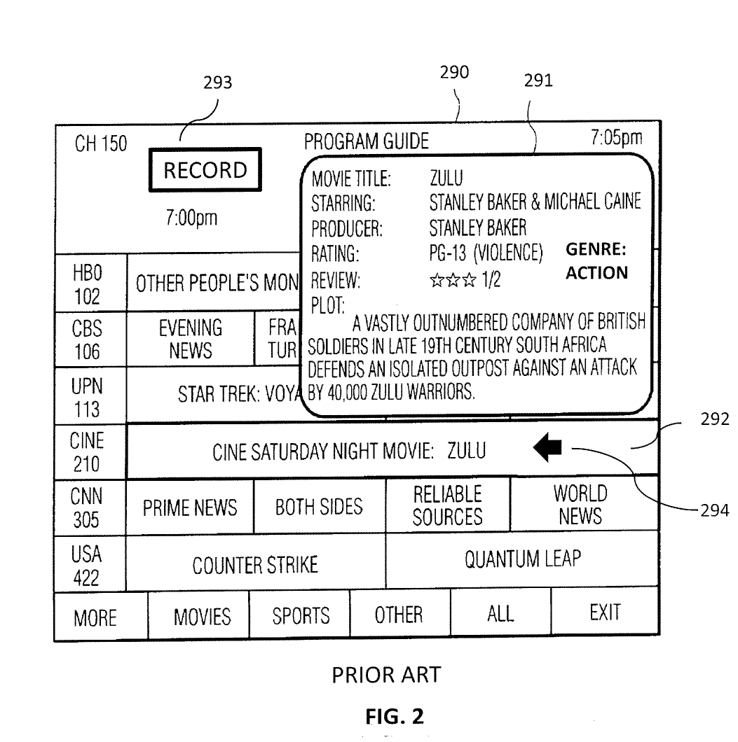

FIG. 6 is a flow chart of an exemplary process according to principles of the present invention. In one embodiment, the exemplary process may be implemented as computer executable instructions which may be executed by, e.g., system controller/processor 115 in receiver 3 of FIG. 3. For example, a computer program product having the computer-executable instructions may be stored in non-transitory computer-readable storage media 90 or 105 of device 3. The exemplary control program shown in FIG. 6, when executed, facilitates processing and displaying of user interfaces shown, for example, in FIGS. 1-2, and 4-5, and controlling of their respective functions and interactions with a user. One skilled in the art can readily recognize that the exemplary process shown in FIG. 6 may also be implemented in hardware (e.g., logic arrays or ASIC), or a combination of hardware and software (e.g., a firmware implementation).

At step 610 of FIG. 6, a request from a user is received via interface 120 of FIG. 3 to record a program. In response to such a request, at step 620, processor/controller 115 of FIG. 3 causes the selected program to be recorded and stored in media storage 90 and/or 105 as previously described in detail in connection with FIG. 3.

At step 630, processor 115 determines if this first recorded version of the requested program contains an abnormality. As described in the BACKGROUND section and is well known in the art, an abnormality in the recording may be due to any number of problems including, e.g., a software error, a hardware error, an incomplete recording, a recording playback failure, a receiving error, a hard drive failure, and a power outage during recording, etc. In addition, an abnormality may include an unexpected change in the programming such as when a presidential speech interrupts the broadcast of the scheduled program or when a sports program runs overtime, etc. If an abnormality has been determined to have occurred at step 630, the first recording of the requested program is tagged to indicate as so at step 650. If there is no abnormality as determined at step 630, then the recording will be processed as normal at step 640.

At step 660, processor 115 automatically determines if there is another occurrence of the requested program from the same source or a different source (e.g., later in time, a different channel, a different medium, a different service provider) using the program guide information. For example, in one exemplary embodiment, if a user is a subscriber of media services/websites (such as, e.g., Itune, Hulu, Netflix, M-GO, etc.), processor 115 may attempt to automatically search those subscribed internet media sites to determine if the requested program is also available from any of those sites. Processor 115 may search those sites e.g., in a predetermined sequence (e.g., as pre-defined by the user).

At step 670, if a user selects to play the first recorded version of the requested media which contains an abnormality at this point (i.e., when a re-recoding has not occurred), a notice 410 shown in FIG. 4 may be displayed to the user indicating that a re-recording has been automatically scheduled and/or the requested program may be obtained in real time from a different source such as e.g., a streaming service without waiting for the re-recording to be completed, because an abnormality has occurred in the existing version of the recorded program. The user is able to either confirm the scheduled re-recording or watch the streaming media in real time by selecting <OK> 420 as shown and instructed in 410 of FIG. 4. Processor 115 of FIG. 3 will then process the user selections and cause electronic device 3 to perform accordingly to the selections as described before in connection with FIG. 3.

At step 680, processor 115 causes the recording of a second recorded version of the requested program either from another occurrence of the program from the same source or a different source. At step 690, this re-recording is also checked to see if it contains an abnormality. If there is an abnormality, then this re-recoding is also tagged as being abnormal and the process repeats as shown in steps 650 to 680 and as described before.

At step 695, when a user selects play back of a requested recording at this point, processor 115 may display a notice such as shown in 510 of FIG. 5, instructing the user that an abnormality has occurred in the original recording of the requested program, but another recording of the same program has been automatically recorded (e.g., either from the same television source or obtained and recorded from the internet), or the user can also watch the same program in real time from a streaming media service. Therefore, the user may select to watch either the original recording, the re-recording, or another real-time streaming of the same requested program by selecting <YOUR SHOWS> key or icon 520, as instructed in 510. Processor 115 of FIG. 3 will then process the user selections and cause electronic device 3 to perform accordingly to the selections as described before in connection with FIG. 3.

While several embodiments have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present embodiments. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings herein is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereof, the embodiments disclosed may be practiced otherwise than as specifically described and claimed. The present embodiments are directed to each individual feature, system, article, material and/or method described herein. In addition, any combination of two or more such features, systems, articles, materials and/or methods, if such features, systems, articles, materials and/or methods are not mutually inconsistent, is included within the scope of the present embodiments.

What is claimed is:

1. A method comprising:
receiving a request to record a program;
recording a first version of the program;
determining whether the first recorded version of the program contains an occurrence of abnormality; and
if the first recorded version of the program contains an occurrence of abnormality, then determining automatically using a program guide, a subsequent to occurrence of the program; and
recording the subsequent occurrence of the program as a second version of the recorded program.

2. The method of claim 1 wherein the occurrence of abnormality comprises one of: 1) a software error, 2) a hardware error, 3) an incomplete recording, 3) a receiving error, 4) a hard drive failure, 5) a power outage during recording, and 6) a change in programming.

3. The method of claim 1 wherein the subsequence occurrence of the program is from a different source than that of the requested program.

4. The method of claim 1 further comprising:
displaying information regarding an existence of the second recorded version of the program; and
displaying the second recorded version of the program in response to a request to play the second recorded version of the program.

5. The method of claim 1 wherein the program comprising one of: 1) audio and video program, and 2) audio-only program.

6. The method of claim 1, further comprising:
if the second recorded version of the program contains an occurrence of abnormality, then automatically determining using the program guide, an additional occurrence of the program; and
recording the additional occurrence of the program as a third recorded version of the program.

7. The method of claim 3 wherein the different source is a streaming media service.

8. A method comprising:
receiving a request to record a program from a first source;
recording a first version of the program from the first source;
determining whether the first recorded version of the program from the first source contains an occurrence of abnormality; and
if the first recorded version of the program from the first source contains an occurrence of abnormality, then determining automatically an availability of the program from a second source.

9. The method of claim 8 further comprising obtaining the program if available from the second source as a replacement for the first recorded version of the program.

10. The method of claim 9 wherein obtaining is by a streaming protocol from a streaming media website.

11. The method of claim 9 wherein obtaining is in response to a user request.

12. An apparatus comprising:
an interface capable for receiving a request to record a program;
a processor capable for processing said request; and
the processor capable for determining whether the first recorded version of the program contains an occurrence of abnormality, if the first recorded version of the program contains an occurrence of abnormality, then automatically determining using a program guide, a subsequent occurrence of the program and recording the subsequent occurrence of the program as a second version of the recorded program.

13. The apparatus of claim 12 wherein the occurrence of abnormality comprises one of: 1) a software error, 2) a hardware error, 3) an incomplete recording, 3) a receiving error, 4) a hard drive failure, 5) a power outage during recording, and 6) a change in programming.

14. The apparatus of claim 12 wherein the subsequence occurrence of the program is from a different source than that of the requested program.

15. The apparatus of claim 12 further comprising:
a video processor capable for providing information regarding an existence of the second recorded version of the program and for providing the second recorded version of the program in response to a request to play the second recorded version of the program.

16. The apparatus of claim 12 wherein the program comprising one of: 1) audio and video program, and 2) audio-only program.

17. The apparatus of claim 12, further comprising:
the processor automatically determining using the program guide, an additional occurrence of the program if the second recorded version of the program contains an occurrence of abnormality and recording the additional occurrence of the program as a third recorded version of the program.

18. The method of claim 14 wherein the different source is a streaming media service.

19. The apparatus of claim 18 further comprising:
a video processor for providing information regarding an existence of the second recorded version of the program; and providing the second version of the program in response to a request to play the second recorded version of the is program, and wherein the second recorded version of the program is abnormality free.

20. A computer program product stored in a non-transitory computer-readable storage media comprising computer-executable instructions for:
receiving a request to record a program;
recording a first version of the program;
determining whether the first recorded version of the program contains an occurrence of abnormality; and
if the first recorded version of the program contains an occurrence of abnormality, then determining automatically using a program guide, a subsequent occurrence of the program; and
recording the subsequent occurrence of the program as a second version of the recorded program.
